(19) United States
(12) Patent Application Publication
(10) Pub. No.: US 2013/0300650 A1
(43) Pub. Date: Nov. 14, 2013

(54) CONTROL SYSTEM WITH INPUT METHOD USING RECOGNITIOIN OF FACIAL EXPRESSIONS

(71) Applicant: HUNG-TA LIU, HSINCHU (TW)

(72) Inventor: HUNG-TA LIU, HSINCHU (TW)

(21) Appl. No.: 13/839,937

(22) Filed: Mar. 15, 2013

(30) Foreign Application Priority Data
May 9, 2012 (TW) 101116507

(51) Int. Cl. G06F 3/01

(52) U.S. Cl. CPC G06F 3/011
USPC 345/156

(57) ABSTRACT

Disclosure is related to a control system with an input method using recognition of facial expressions. The system includes an image capturing unit, an image processing unit, a database, and a computing unit. The image capturing unit captures an input image having a facial expression when a user uses lip language. The image processing unit, connected with the image capturing unit, is used to receive and recognize the facial expression shown in the input image. The database stores a plurality of reference images and each of which indicates a corresponding control command. The computing unit, connected with the image processing unit and the database, performs comparison between the facial expression recognized by the image processing unit and the reference images retrieved from the database. The result of comparison finds out the control command which is used to operate an electronic device by this control system.

### BACKGROUND

1. Technical Field

The present invention is related to a control system, in particular to the control system with an input method using recognition of facial expressions.

2. Description of Related Art

With advancement of the scientific technology, electronic devices have been developed for humans to have more conveniences. It is important when the developers attempt to find out a user-friendly way to advance operations of the electronic devices. For example, people need a period of time to learn how to use the devices correctly such as a computer mouse, keyboard, and remote control which are particularly used to operate the computer or television. It may exist a threshold for the users who are not familiar with the operations of the input devices. More, the described input devices may occupy a certain space; therefore the users may consider how to make room to store up the devices even the remote control. In addition, the computer mouse or keyboard may cause the users to be unhealthy when they feel fatigued and ache while using the devices for a long time.

### SUMMARY

Provided in one of the embodiments of the present invention is a control system with an input method using recognition of facial expressions. The control system includes an image capturing unit, an image processing unit, a database, a computing unit. The image capturing unit captures an input image of a user's facial expression, in which the facial expression can be the expression showing the mouth motion when the user is talking or performing lip language. The image processing unit, connected with the image capturing unit, receives and recognizes the facial expression in the input image.

Furthermore, the database records a plurality of reference images, and control commands one-by-one corresponding to the reference images. The computing unit, connected with the image processing unit and the database, receives the facial expression recognized by the image processing unit, and conducts comparison between the recognized facial expression and the reference images in the database. Therefore a control command with respect to the reference image matched up with the facial expression can be acquired.

The control system may thereby use the control command to control an electronic device by way of facial expressions.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

FIG. 1 shows a block diagram schematically describing a control system with an input method using recognition of facial expressions in accordance with the present invention;

FIG. 2 shows an embodiment of the control system using recognition of the facial expressions as an input method of the present invention;

FIG. 3 is a schematic diagram showing facial expression and lip language in one embodiment of the present invention;

FIGS. 4A-4C schematically show the facial expressions of eyebrows according to one embodiment of the present invention;

FIGS. 5A-5D schematically show the facial expressions of eyes according to one embodiment of the present invention;

FIGS. 6A-6C schematically show the facial expressions of mouth according to one embodiment of the present invention;

FIG. 7 is a schematic diagram of the embodiment showing a face wearing an auxiliary object according to one embodiment of the present invention; and

FIGS. 8A-8C schematically shows the sign language in one embodiment of the present invention.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

Embodiment in accordance with a control system with input method using facial expressions is described as follows.

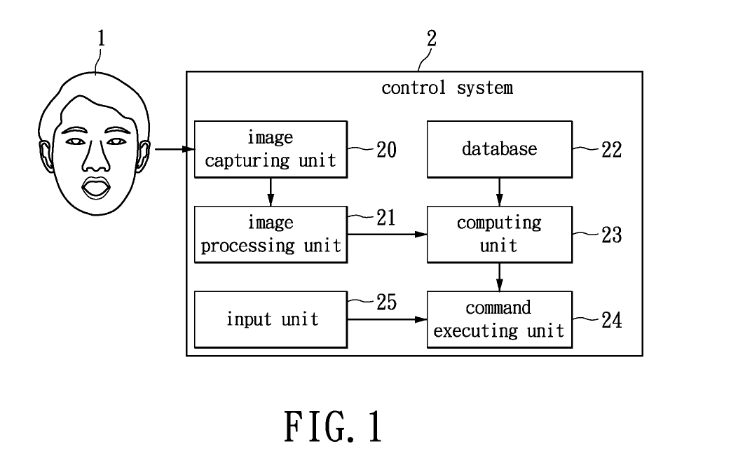

Reference is made to FIG. 1 depicts a block diagram describing an embodiment of the control system with input method using facial expressions. The shown control system 2 includes an image capturing unit 20, an image processing unit 21, a database 22, a computing unit 23, and a command executing unit 24. The image capturing unit 20 is coupled to the image processing unit 21. The image processing unit 21, database 22, and the command executing unit 24 are separately connected with the computing unit 23.

This image capturing unit 20 may be implemented by a camcorder or a camera with CCD or CMOS sensor which retrieves an input image made by a user 1. The input image includes the user's facial expression such as the user's gesture with each or in combination of eyebrows, eyes, ears, noses, mouth, and tongue. For example, when the user 1 speaks or use lip language, the instant mouth motion forms various shapes of mouth. The image capturing unit 20 captures the input image having the facial expression. The input image is then transferred to the image processing unit 21 for rendering image analysis and processing by an image processing algorithm. The facial expression in the input image can be identified for further comparison. The mentioned image processing algorithm is for identifying the facial expressions. The algorithm may be a method for extracting and analyzing image characteristics, a method made by neural networks, a method of template matching, or a method for geometrical modeling, by which the algorithm allows to identify the various facial expressions shown in the input image.

The database 22 records multiple reference images and each of them corresponds to at least one control command. Every reference image may be indicative of one image specified to one facial expression. The control command may be exemplarily directed to capturing image of the user 1, initiating display of an electronic device, shutting down the display of the electronic device, locking up a picture on the display, unlocking the display, shutting down the electronic device, initiating the electronic device, deactivating a specific function of the electronic device, activating the function of the electronic device, paging up, paging down, entering, quitting, canceling, zooming in, zooming out, flipping, rotating, playing video or music, opening a program, closing the program, sleeping, encrypting, decrypting, data computing or comparing, data transmitting, displaying data or image, or conducting image comparison. The listed control commands may be part of the examples which are configured and executed by the control system 2, but not used to limit the items or types of the possible control commands.

The computing unit 23 is used to receive the facial example recognized by the image processing unit 21, and conduct a comparison of the facial expression with the reference images recorded in the database 22. It is determined if the database 22 includes the reference image consistent with the recognized facial expression. While it is determined there is a reference image matched with the facial expression, a control command with respect to the reference image can be acquired.

The command executing unit 24 is configured to receive the control command read by the computing unit 23. A process is initiated to operate the electronic device (not shown) responsive to the control command. For example, the control command is executed to initiate the display of the electronic device for displaying pictures. The electronic device may be a device capable of data computation such as a desktop computer, a notebook computer, a tablet PC, a smart phone, a personal digital assistant, or a television.

According to the exemplary embodiment of the invention, the control system 2 may be built in the electronic device, and the image capturing unit 20 may be built in the electronic device or externally disposed. Exemplarily, the image processing unit 21, computing unit 23 and command executing unit 24 may be integrated into the electronic device, and preferably the related computation tasks may be executed by the device's central processor, embedded processor, micro-controller, or any other digital signal processor. Furthermore, the image processing unit 21, computing unit 23 and command executing unit 24 may be embodied by a proprietary processing chip. The database 22 may be in a non-volatile storage of the electronic device, for example, the hard disk, flash memory, or EEPROM.

Moreover, the control system 2 also includes an input unit 25 for generating an input command while receiving the user 1's manipulation except for the described facial expressions. The input unit 25 may be a computer mouse, keyboard, touch panel, handwriting tablet, or an audio input device (microphone). The command executing unit 24 may further receive the input command from the input unit 25, and execute the input command for controlling the electronic device after conducting the control command. For example, the user 1 controls the electronic device to initiate a specific program by his facial expression in the beginning. After that, the input unit 25 is provided for the user 1 to generate an input command for selecting one item of the initiated program. It is noted that the input unit 25 may not be the essential element to implement the control system 2 in one embodiment of the present invention.

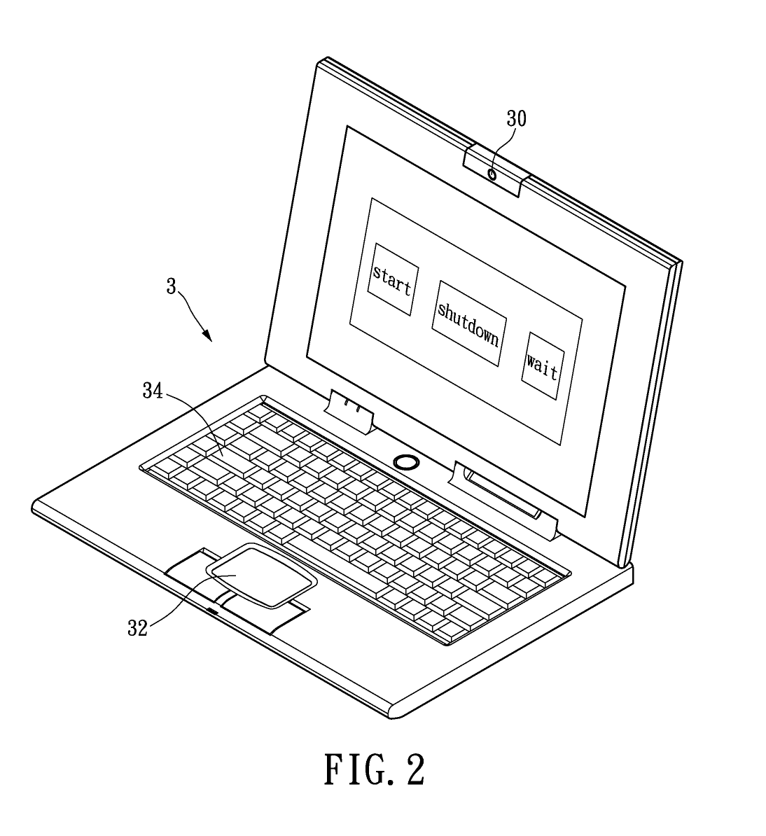

Reference is made to FIG. 2 describing a schematic diagram of the control system with the input method using the facial expressions.

In view of the block diagram shown in FIG. 1, the control system 2 is exemplarily applicable to the electronic device 3 such as a notebook computer. In this example, the image capturing unit 20 may be a capture lens 30 disposed with the notebook computer. The user may stand up or sit down in front of the computer, and face the capture lens 30. The capture lens 30 is able to capture the user's facial expressions. For instance the user performs lip language and the mouth motion drives a change of the facial expression. The input image thereof may be delivered to the central processor of the computer system for image processing. The process may also read the reference images stored in a database (not shown) for conducting comparison. The central processor then executes an operation based on a control command according to the result of the comparison. Therefore, it is achieved that the facial expression is served to operate the computer system.

In addition to the capture lens 30 of the device (computer system) used to capture the user's image of facial expression as an input command, an input unit originally equipped with the electronic device 3 may also be used together for operating the tasks made by multiple steps. The input unit, as shown in FIG. 2, may be the touch pad 32 or keyboard 34.

The following specification describes various types of the facial expressions as an input method in detail.

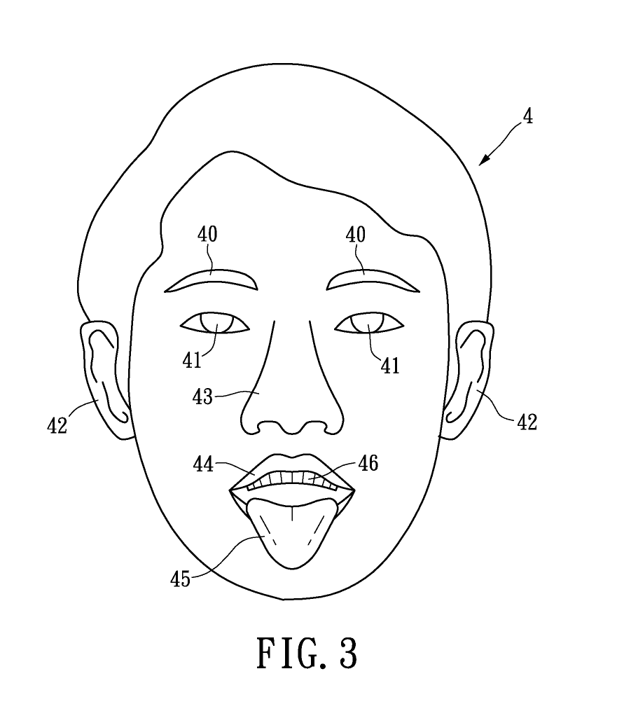

FIG. 3 shows a schematic diagram of the user's face. The related facial expression is as an input, and a range covering the user's face 4 is retrieved by the image capturing unit 20. The facial expression can be generated by expression of the face 4's eyebrows, eyes, ears, nose, mouth, teeth, or tongue. The image processing unit 21 computes absolute characteristic position, absolute displacement, relative characteristic position, or relative displacement according to the distances among the organs such as the eyebrows 40, eyes 41, ears 42, nose 43, mouth 44, tongue 45 or teeth 46 shown in FIG. 3. Therefore, the various facial expressions may be recognized by the position and displacement analysis. The facial expressions express the user 1's various emotions including happy, angry, sad, fear, evil, frightened, and confused.

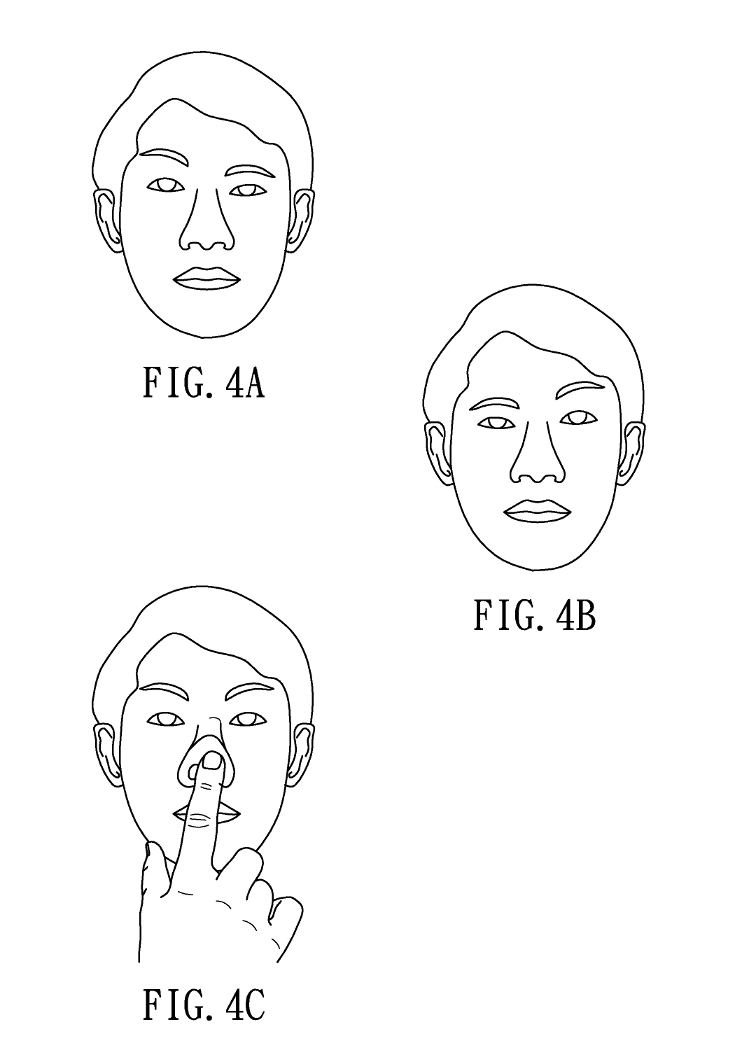

References are made to FIGS. 4A through 4C schematically illustrating the user 1's facial expressions. FIGS. 4A through 4C show the facial expressions made by the different characteristic positions of the eyebrows 40. The facial expression shows unilateral raising eyebrow by either raising the right eyebrow in FIG. 4A, or raising the left eyebrow in FIG. 4B. Expression of bilateral raising eyebrow is described when both eyebrows are raised as shown in FIG. 4C. The image processing unit may determine if one or both the eyebrows 40 is raised according to the position of the eyebrows 40 related to eyes 41, or a radian of the eyebrows 40. FIG. 4C also illustrates the expression of the user 1 squeezing nose 43.

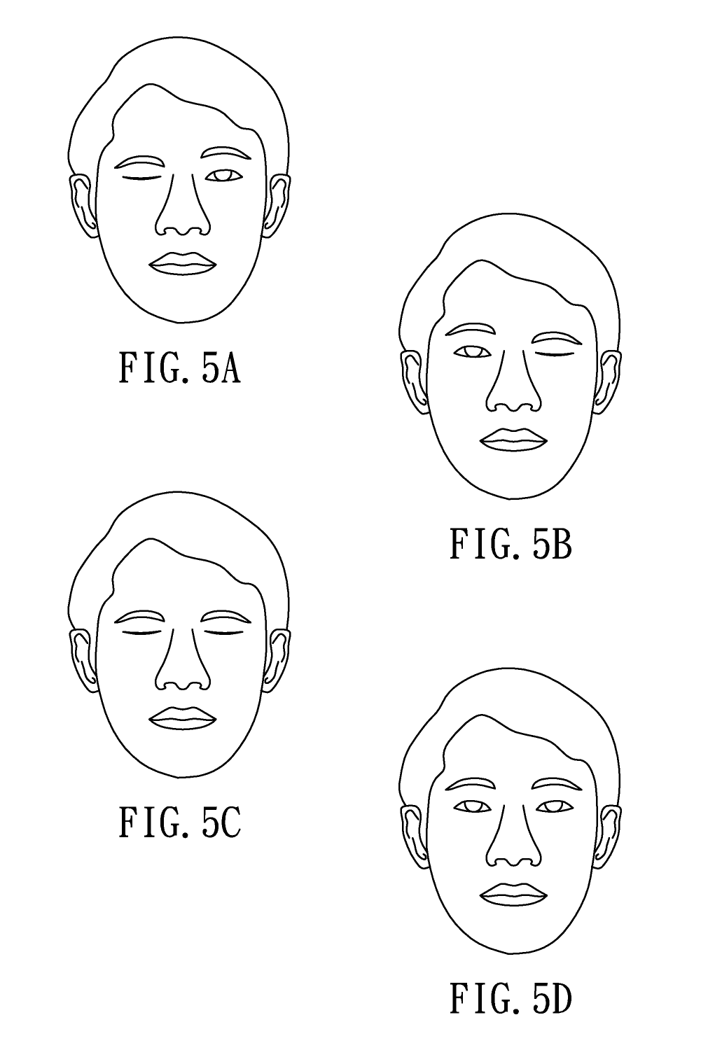

FIGS. 5A through 5D show one further diagram of facial expression in addition to the eyebrows 40 shown in the above-described figures.

FIGS. 5A through 5D illustrate the facial expressions based on the different characteristic positions of eyes 41. The expression of closing single eye is such as closing the right eye and opening left eye shown in FIG. 5A, or opening right eye and closing left eye shown in FIG. 5B. FIG. 5C further shows the expression of closing both eyes. FIG. 5D shows the expression of opening both eyes. The image processing unit may recognize open or close state of the user 1's eyes by determining and analyzing the shape of the eyes 41 or position and size of the pupils.

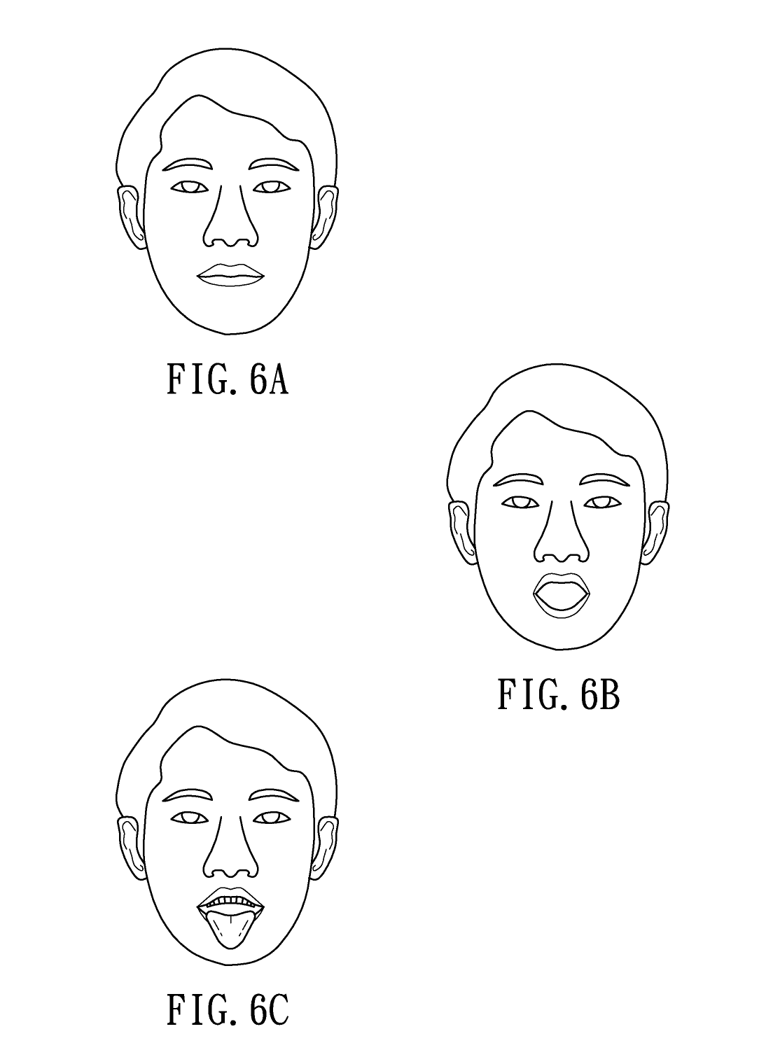

The characteristic positions of the mouth 44 of the user 1 shown in FIGS. 6A through 6C may be referred to determine the facial expressions.

In FIG. 6A, expression of closing the mouth 44 is shown. FIG. 6B shows the expression of opening the mouth 44. FIG. 6C shows the facial expression of combining the states of mouth 44 and tongue 45 of the user 1. In which, the expression of combining opening mouth and extending tongue is shown in FIG. 6C. However, the expressions shown in FIGS. 6A through 6C are merely a small number of the examples denoting the facial expressions made by the present invention. When the user 1 speaks or performs lip language, much more changes of the shapes or characteristic positions of the mouth 44 may be created because of the various shapes of mouth 44. Those changes may be recognized by the image processing unit 21.

The facial expressions described in FIGS. 3 through 6 are merely a small number of the examples implemented in accordance with the present invention. Some more facial expressions such as protruding lips while the lips is making rounded “o” shape, clamping teeth, or the positions of the user 1's ears 42 or noise 43 may be made in the present invention. The facial expressions shown in the FIGS. 3 through 7 may be combined with the expression made by the ears 42 or nose 43. For example, a set of facial expressions may be formed as combining the closing right eye of FIG. 5A and opening mouth of FIG. 6B.

Furthermore, facial expression may be a characteristic position of each of the face organs, or in combination of serial changes of the organs. The displacements among the user 1's eyebrows 40, eyes 41, ears 42, nose 43, or mouth 44 may be recognized to be the facial expressions. The facial expressions in the current examples are such as the variations of the eyebrows 40 shown in FIGS. 4A to 4C, the eyes 41 of FIGS. 5A to 5D including blinking single eye, alternately blinking eyes, or simultaneous blinking eyes, and the variations of closing or opening mouth shown in FIGS. 6A to 6C, including combination of the expressions of opening mouth, closing mouth, and extending tongue, or the changes of shape as the user performing lip language or speaking.

Furthermore, the illustrated facial expressions may be combined with the simultaneous motions of other facial organs. One of the facial expressions is such as closing single eye shown in FIG. 4A and FIG. 4B combined with opening mouth and closing mouth shown in FIGS. 6A through 6B.

These descriptions of the facial expressions are merely used to illustrate the examples of the present invention, but not to limit the scope of the invention using the facial expression as an input method. By analyzing the combinations of the various states of the user 1's facial organs, the meanings of number, quantity, English letters, finish, “OK”, time out, crash, dead, walk, come or go can be denoted. When an input enters the control system 2 shown in FIG. 1, a control command corresponding to the input can be acquired by the image processing unit 21's recognition and the computing unit 23's comparison. The command executing unit 24 then executes the control command for controlling the electronic device. The device can be controlled by recognizing the facial expressions as the inputs.

Embodiment of the control system with an input method using facial expression:

Reference is again made to FIG. 1. The input images retrieved by the image capturing unit 20 may include an auxiliary object which is used to be allocated on the user 1's face. The auxiliary object is such as a pen, ruler, lipstick or communication equipment which is such as a wireless earphone and microphone. The reference images stored in the database 22 may include the images of facial expression combined with the similar or identical auxiliary objects. The reference images are for the comparison conducted by the computing unit 23.

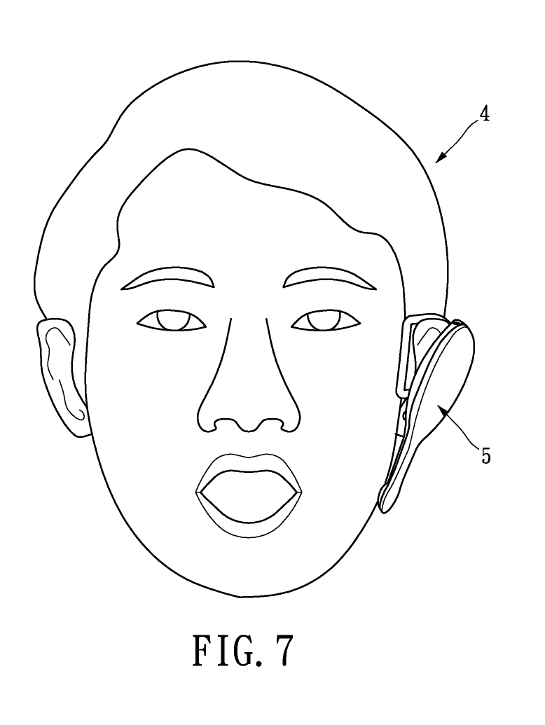

A schematic diagram of an embodiment of an input image shown in FIG. 7 is referred to understand the present invention. The input image of FIG. 7 shows a wireless earphone 5 is worn on an ear 42 of the user 1 besides the facial expression. When the image processing unit 21 receives this input image, the above-described image identifying method for identifying the facial expression can also be used to identify the wireless earphone worn on the ear 42 of the user 1. For example, by analyzing the contour and colors of the ear 42 and wireless earphone 5, it is determined that one portion of the ear 42 is covered by the wireless earphone 5. Therefore, the auxiliary object is recognized that it is worn on the ear 42. After that, when the computing unit 23 receives the information of the facial expression and the auxiliary object recognized by the image processing unit 21, the computing unit 23 performs the comparison by referring to the reference images in the database 22 for acquiring the corresponding control command.

In an exemplary example, it is assumed that the database 22 stores the facial expressions, for example the shape of mouth as speaking “voice”, auxiliary object, the related positions, and similar reference images identified by the image processing unit 21, and the control command. In this example, the control command is such as the function of activating the voice communication of the electronic device. When the user 1 faces the image capturing unit 20 and speaks “voice” by his worn wireless earphone 5, the control system 2 automatically activates the program of voice communication of the electronic device by identification and comparison process. Thereby the user 1 may conduct voice communication by his wireless earphone 5. The input image with the auxiliary object in the example shown in FIG. 7 and related description may not be used to limit the present invention.

The input may be another image having the user 1 whose mouth 44 holds an auxiliary object such as a pen. The auxiliary object may denote difference meanings while it is placed toward a specific direction.

The same or similar portions of the present embodiment with the above-described embodiment may not be repeated in the following descriptions.

One more embodiment of the control system with an input method using facial expression:

Reference is again made to FIG. 1. The input image retrieved by the image capturing unit 20 may include the user 1's gesture or posture of lower limbs in addition to the user 1's facial expression. The image processing unit 21 then analyzes and identifies the combination of facial expression and gesture or posture of lower limbs from the input image. The reference images stored in the database 22 may include the images combining the facial expressions with the gestures or postures of lower limbs. The reference images are provided for the computing unit 23 to conduct the comparison. Based on the reference images in the database 22 and the facial expressions and gesture or posture of lower limbs identified by the image processing unit 21, the comparison performed by the computing unit 23 may obtain the control command correspondingly. The control command is delivered to a command executing unit 24 for further execution.

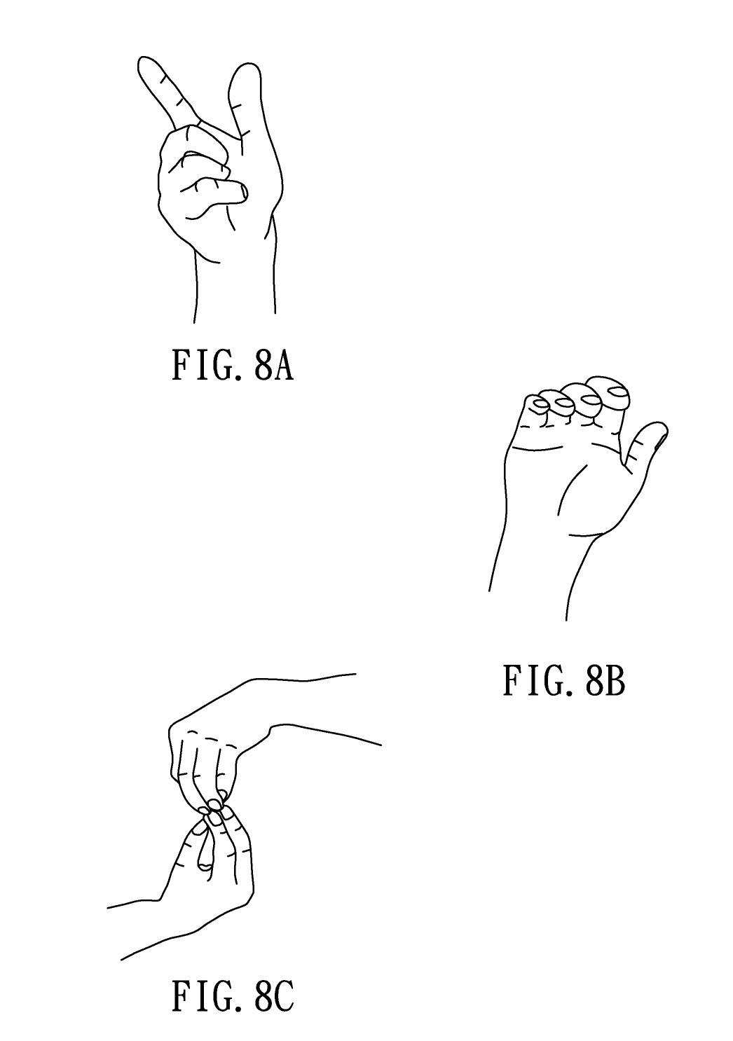

The gesture is such as the motion of user 1's fingers, palms, or arms, or in combination thereof. The gestures form the sign language and are such as the pointing hand, bending the fingers, and touching the fingers' tips shown in FIGS. 8A through 8C.

The gestures may not be limited to hands' motions, including the motions of fingers or/and palms, or arm's motions. Any combination of the hands and arms' gestures may be included. The combination may be fisting two hands, praying hands by combining the palms, outstretching single or multiple fingers, crossing fingers, outstretching two arms, or in combination of the gestures. For example, the sign language may form the classical gestures when the user 1 combines the fingers, palms, and/or arms.

By performing the described facial expressions together with the various gestures of the user 1, the combination may form the input image denoting number, quantity, English letter, finish, OK, suspend, crash, dead, walk, come or go which becomes the input of the control system 2. By means of the identification made by the image processing unit 21 and comparison by the computing unit 23 of the control system 2, the corresponding control command may be acquired. The command executing unit 24 executes the control command for configuring the electronic device to be operated responsive to the user's gesture.

The redundant descriptions may not be provided since the since the further retrieval and identification of the lower limbs may be similar with the above-described gestures of the hands.

The facial expressions formed by the motions of mouth and lips, and the sign language using gestures are exemplarily described, but not used to limit the present invention. The input images used in the embodiments of the present invention may not be limited to the combination of described facial expressions and gestures. The input image may also include the user's facial expression, gesture, or/and the auxiliary object for generating much more possible combinations of the inputs for the computing unit 23 to conduct the comparison.

Possible effects of the embodiments:

In accordance with one of the embodiments of the present invention, the control system adopts the user's facial expression and emotion to be an input for operating the electronic device. To compare with the other tangible input devices, the present invention provides an input method with features of more intuitive and easy to understand because the user has excellent capability of controlling and coordinating his own facial expressions. The invention effectively eliminates the difficulties of learning the traditional input devices.

Furthermore, the input method using the user's facial expression can save the space occupied by the tangible input devices. The user may avoid the injure resulting in clicking the computer mouse or striking the keyboard for a long time.

It is advantageous that the control system in the embodiments of the present invention may further identify some other body languages to be one of the input methods in addition to the described facial expressions. The body language may be gesture of hands, the auxiliary object, or in combination with the facial expressions in order to generate various types of controlling means. The invention is beneficial to precisely control the electronic device. The electronic device may be operated in communication with the user easily responsive to the user's body motions.

It is worth noting that the control system in accordance with the present invention is able to perform the lip language, speaking, or/and sign language to be one of the inputs. Based on the invention, even though the user is at the circumstance unable to type words, or speak (for example the disabled person, or in outer space), the facial expressions or gestures can also be the inputs for configuring the electronic device.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A control system with input method using recognition of facial expressions, comprising:
an image capturing unit, retrieving an input image having a user's facial expression, which is the user's lip language or mouth motion when he is talking;
an image processing unit, connected with the image capturing unit, receiving and recognizing the facial expression of the input image;
a database, recording a plurality of reference images and at least one control command corresponding to every reference image;
a computing unit, connected with the image processing unit and the database, receiving the facial expression recognized by the image processing unit and comparing the reference images in the database with the recognized facial expression, for acquiring the control command with respect to the reference image corresponding to the recognized facial expression;
wherein, the control system controls an electronic device according to the control command with respect to the inputted facial expression.

2. The control system according to claim 1, further comprising:
a command executing unit, connected with the computing unit, for receiving the control command obtained from the computing unit, and executing the control command for operating the electronic device.

3. The control system according to claim 1, wherein the command executing unit controls the electronic device to photograph the user's image, turn on a display of the electronic device, turn off the display, lock up a picture on the display, unlock the picture, turn off or turn on the electronic device, or activate or deactivate a function of the electronic device according to the control command.

4. The control system according to claim 2, wherein the command executing unit controls the electronic device to photograph the user's image, turn on a display of the electronic device, turn off the display, lock up a picture on the display, unlock the picture, turn off or turn on the electronic device, or activate or deactivate a function of the electronic device according to the control command.

5. The control system according to claim 1, wherein the command executing unit controls the electronic device to page up, page down, enter, quit, cancel, zoom in, zoom out, flip, rotate, play multimedia, open program, close program, sleep, or shutdown according to the control command.

6. The control system according to claim 2, wherein the command executing unit controls the electronic device to page up, page down, enter, quit, cancel, zoom in, zoom out, flip, rotate, play multimedia, open program, close program, sleep, or shutdown according to the control command.

7. The control system according to claim 1, wherein the image processing unit resolves the facial expression based on an absolute characteristic position or relative characteristic position of the user's eyebrows, eyes, ear, nose, tooth, or mouth.

8. The control system according to claim 7, wherein the image processing unit recognizes the facial expression based on a distance or displacement among the user's facial eyebrows, eyes, ear, nose, tooth, and/or mouth.

9. The control system according to claim 1, wherein the facial expression further comprises happy, angry, sad, fear, evil, frightened, or confused expression.

10. The control system according to claim 1, wherein the facial expression further comprises each or in combination of the expressions including the user's unilateral raising eyebrow, bilateral raising eyebrow, eyes open, one eye closed, eyes closed, and squeezing nose.

11. The control system according to claim 1, wherein the facial expression further comprises each or in combination of the expressions including the user's one eye blink, eyes alternate blink, and eyes simultaneous blink.

12. The control system according to claim 1, wherein the input image further comprises the user's gesture or posture of lower limbs, and the image processing unit also recognizes the user's gesture or posture of lower limbs;
the reference images in the database also includes the images of the facial expression combined with the gesture or posture of lower limbs; the computing unit further receives the gesture or posture of lower limbs recognized by the image processing unit, and compares the image with the reference images for acquiring the control command with respect to the reference image corresponding to the combination of the facial expression and the gesture or posture of lower limbs.

13. The control system according to claim 12, wherein the gesture is a sign language.

14. The control system according to claim 12, wherein the gesture means outstretching single finger, outstretching multiple fingers, fisting one hand, fisting hands, praying hands, crossing fingers, outstretching one arm, or outstretching two arms.

15. The control system according to claim 13, wherein the sign language is one of the gestures including outstretching single finger, outstretching multiple fingers, fisting one hand, fisting two hands, praying hands, crossing fingers, outstretching one arm, and outstretching two arms.

16. The control system according to claim 12, wherein the gesture means clockwise movement of hand, counter-clockwise movement of hand, outside to inside movement of hand, inside to outside movement of hand, movement of clicking, crossing, checking, or flapping.

17. The control system according to claim 13, wherein the sign language is one of the gestures including clockwise movement of hand, counter-clockwise movement of hand, outside to inside movement of hand, inside to outside movement of hand, movement of clicking, crossing, checking, and flapping.

18. The control system according to claim 1, wherein the input image includes an auxiliary object and the facial expression includes gesture collocated with the auxiliary object.

19. The control system according to claim 1, further comprising:
an input unit, connected with the command executing unit, receiving the user's input and generating an input command;
wherein, the command executing unit operates the electronic device according to the control command and the input command, and the input unit is a touch panel, a keyboard, a computer mouse, a handwriting tablet, or an audio input device.
